(19) United States
(12) Patent Application Publication
(10) Pub. No.: US 2023/0007896 A1
(43) Pub. Date: Jan. 12, 2023

(54) MOLTEN SALT REACTOR IMPROVEMENTS

(71) Applicant: CZERO, INC., Goleta, CA (US)

(72) Inventors: Fadl SAADI, Goleta, CA (US); Samuel SHANER, Goleta, CA (US)

(21) Appl. No.: 17/782,846

(22) PCT Filed: Dec. 4, 2020
(86) PCT No.: PCT/US2020/063406

§ 371 Date: Jun. 6, 2022

(51) Int. Cl. C01B 3/34; B01J 19/00; B01J 10/00

(52) U.S. Cl. CPC C01B 3/348; B01J 19/0013; B01J 10/005; C01B 2203/0833; C01B 2203/0894; C01B 2203/1614; B01J 2204/002; B01J 2204/005; B01J 2219/00058; B01J 2219/00452; B01J 2219/00873; B01J 2219/182; B01J 2219/1943

(57) ABSTRACT

A method of preheating a feed to a molten material reactor comprises heating a hydrocarbon feed in a first heat exchanger using a cooled product gas to produce a heated hydrocarbon feed stream, pyrolyzing at least a portion of the C₂₊ hydrocarbons in the heated feed stream in a pyrolysis reactor to produce a pyrolyzed hydrocarbon stream, and heating the pyrolyzed hydrocarbon stream in a second heat exchanger using a product gas to produce a pre-heated feed gas. The heated hydrocarbon feed stream comprises methane and one or more C₂₊ hydrocarbons.

### CROSS-REFERENCE TO RELATED APPLICATIONS

This application claims priority to U.S. Provisional Application No. 62/944,819, filed on Dec. 6, 2019, and entitled “MOLTEN SALT REACTOR IMPROVEMENTS,” which is incorporated herein by reference in its entirety.

### STATEMENT REGARDING FEDERALLY SPONSORED RESEARCH OR DEVELOPMENT

None.

### BACKGROUND

At present, industrial hydrogen is produced primarily using the steam methane reforming (SMR) process, and the product effluent from the reactors contains not only the desired hydrogen product but also other gaseous species including gaseous carbon oxides (CO/CO₂) and unconverted methane. Separation of the hydrogen for shipment or storage and separation of the methane for recirculation back to the reformer is carried out in a pressure swing adsorption (PSA) unit, a costly and energy-intensive separation. Generally, the carbon oxides are released to the environment. This separation process exists as an independent unit after reaction. Overall the process produces significant carbon dioxide. Natural gas is also widely used to produce power by combustion with oxygen, again producing significant amounts of carbon dioxide.

### SUMMARY

In an aspect, a molten reactor heater comprises a molten reactor vessel, a molten material disposed within the molten reactor vessel, and an indirect heat exchanger disposed within the molten reactor vessel in contact with the molten material.

In an aspect, a molten material reactor comprises a reactor vessel, a gas distributor disposed in a lower portion of the reactor vessel, an auger disposed in an upper portion of the reactor vessel, and an outlet in an upper portion of the reactor vessel. The auger passes through the outlet and is configured to pass carbon out of the upper portion of the reactor vessel through the outlet.

In an aspect, a method of operating a molten material reactor comprises contacting a hydrocarbon gas with a molten material in a reactor vessel, producing hydrogen and solid carbon in the reactor vessel, transporting the solid carbon from a top of the molten material using an auger disposed in an upper portion of the reactor vessel towards an outlet in the reactor vessel, and removing the solid carbon from the reactor vessel through the outlet in the reactor vessel.

In an aspect, a method of preheating a feed to a molten material reactor comprises heating a hydrocarbon feed in a first heat exchanger using a cooled product gas to produce a heated hydrocarbon feed stream, pyrolyzing at least a portion of the C₂₊ hydrocarbons in the heated feed stream in a pyrolysis reactor to produce a pyrolyzed hydrocarbon stream, and heating the pyrolyzed hydrocarbon stream in a second heat exchanger using a product gas to produce a pre-heated feed gas. The heated hydrocarbon feed stream comprises methane and one or more C₂₊ hydrocarbons.

In an aspect, a method of condensing vaporized material comprises cooling a vapor product from a molten salt reactor in a heat exchanger, wherein the vapor product comprises a vaporized salt, condensing at least a portion of the vaporized salt in the vapor product in the heat exchanger, and recycling the condensed portion of the vaporized salt to the molten salt reactor.

These and other features will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a schematic illustration of a molten salt reactor system according to some embodiments.

FIGS. 2A-2B are schematic illustrations of a molten salt reactor according to some embodiments.

### DETAILED DESCRIPTION

The conversion of natural gas into hydrogen or power today is practiced commercially using processes that produce significant quantities of carbon dioxide. As the global community seeks to reduce carbon dioxide emissions it is desired to find cost effective processes to make use of natural gas to produce hydrogen or power without generating carbon dioxide. The present systems and methods make conversion of natural gas or other fossil hydrocarbons into hydrogen and/or heat and steam for power possible without producing carbon dioxide while producing instead solid carbon.

The systems and methods disclosed herein teach the preparation and use of novel high-temperature catalytic reactors containing molten materials such as molten salts and/or metals for the transformation of natural gas to solid carbon with the co-production of hydrogen or other chemicals and/or power without producing stoichiometric carbon oxides. The various embodiments include continuous processes whereby carbon can be produced from natural gas and separated from the molten media together with gas phase chemical co-products and reactors and methods for removal of the carbon. In some embodiments, methane or other light hydrocarbon gases are fed into a reactor system containing a molten salt with a catalyst and react to produce carbon and molecular hydrogen as a chemical product. The reaction is endothermic and heat is provided to the reactor. The salt is an excellent heat transfer medium and can be used to facilitate heat transfer into the reactor. In this process, the solid carbon can be separated and removed as a solid in the process.

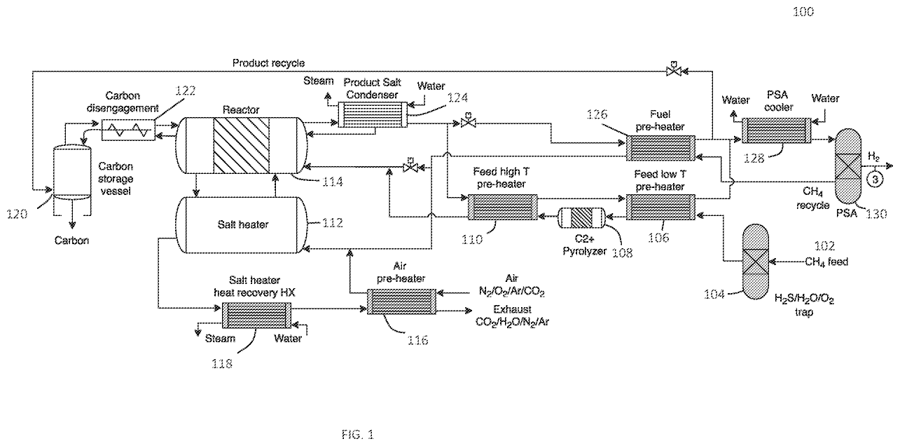

FIG. 1 illustrates a system 100 for producing hydrogen and solid carbon from a hydrocarbon feed stream 102. The hydrocarbon feed stream can comprise a hydrocarbon including any suitable gaseous hydrocarbons. In some embodiments, the feed stream can comprise natural gas. As used herein, the natural gas can generally include and/or consist primarily of light alkanes including methane, ethane, propane, and butane, which are molecules containing only carbon and hydrogen. In some embodiments, the feed can comprise other components and hydrocarbons (e.g., minor amounts of hydrocarbons) containing elements other than hydrogen and carbon as are sometimes present in natural gas or other hydrocarbon feedstocks (e.g., minor amounts of oxygen, nitrogen, carbon dioxide, sulfur, water, etc.).

As shown, the hydrocarbon feed stream 102 can pass through an optional absorbent bed 104 to remove various components in the feed stream. For example, trace amounts of contaminants such as nitrogen, water, oxygen, carbon dioxide, and some sulfides (e.g., odorants in pipeline gas, mercaptans, etc.) can be present that can be removed upstream of the process.

The cleaned feed gas can then pass to a first heat exchanger 106 to preheat the gas to a first temperature less than a pyrolysis temperature of the components of the feed gas. An intermediate pyrolysis reactor 108 can be used in some embodiments to pyrolyze any C₂₊ hydrocarbon components (ethane, ethylene, propane, propylene, and higher hydrocarbons) in the feed gas to prevent carbonization and plugging in the high temperature heat exchanger 110. Once the feed gas is pre-heated, it can pass to the molten salt reactor 114.

In use, the pyrolyzer reactor 108 can be useful in allowing the feed to the molten salt reactor 114 to be heated to a higher temperature than would otherwise be possible without removing the C₂₊ components. The pyrolyzer reactor 108 thereby allows for a method of preheating a feed to a molten salt reactor that includes heating the hydrocarbon feed stream 102 in the first heat exchanger 106 using a cooled product gas to produce a heated hydrocarbon feed stream. The heated hydrocarbon feed stream comprises methane and the one or more C₂₊ hydrocarbons. At least a portion of the C₂₊ hydrocarbons in the heated feed stream can be pyrolyzed in the pyrolysis reactor 108 to produce a pyrolyzed hydrocarbon stream. The pyrolyzed hydrocarbon stream can then be heated in a second heat exchanger 110 using a product gas to produce a pre-heated feed gas. The heat exchange in the second heat exchanger 110 can result in the product gas from the molten salt reactor being cooled to thereby produce the cooled product gas used to supply heat in the first heat exchanger 106. It is expected that the C₂₊ hydrocarbon components can begin to pyrolyze between 500° C. and 900° C., depending on the composition of the hydrocarbons and the absence or presence of any materials acting as a catalyst. The heated hydrocarbon feed stream can leave the first heat exchanger at a temperature of between 40-850° C., or up to 900° C. to remain below a pyrolysis temperature of the C₂₊ components in feed gas. The pre-heated feed gas stream can leave the second heat exchanger 110 at a temperature of between 700-1100° C., which would result in any C₂₊ components pyrolyzing if they are not removed from the feed stream in the pyrolysis unit prior to reaching the second heat exchanger 110. Pyrolysis of the heated hydrocarbon feed stream in the second heat exchanger is therefore prevented based on pyrolyzing the portion of the C₂₊ hydrocarbons in the heated feed stream.

In some embodiments, the pyrolysis reactor 108 can comprise a pyrolysis catalyst in order to pyrolyze the C₂₊ components at the temperature of the heated hydrocarbon feed stream leaving the first heat exchanger 106. Any suitable pyrolysis catalyst can be used including those comprising carbon, nickel, or the like. In some embodiments, the pyrolysis unit can comprise a solid comprising a metal (e.g. Ni, Fe, Co, Cu, Pt, Ru, etc.), a metal carbide (e.g. MoC, WC, SiC, etc.), a metal oxide (e.g. MgO, CaO, Al₂O₃, CeO₂, etc.), a metal halide (e.g., MgF₂, CaF₂, etc.), solid carbon, and any combination thereof. In order to limit any downstream pyrolysis of the hydrocarbon components, the components in the second heat exchanger 110 in contact with the pyrolyzed hydrocarbon stream can be made from materials configured to be non-catalytic to pyrolysis reactions. For example, the components in the second heat exchanger 110 in contact with the pyrolyzed hydrocarbon stream comprising SiC or an alumina forming alloy (e.g., Kanthal® APMT or aluminized Ni superalloy).

The molten materials in the reactor 114 can be heated in a separate heater. For example, when the molten materials comprise molten salt, the molten salt within the molten salt reactor 114 can be heated in a salt heater 112. The heat for the salt heater can be applied by direct heat exchange (e.g., contacting combustion gases with the molten salt), indirect heat exchange (e.g., where the components do not directly contact each other), and/or electrical heating elements. For the direct and indirect heat exchange, a source of oxygen (e.g., air, oxygen enriched air, etc.) can be combined with a hydrocarbon stream such as a methane recycle stream and combusted to produce heat to melt the salts in the salt heater. The product gas can pass to a heat exchanger 118 to allow for additional heat to be extracted from the combustion gases. For example, steam for use in other parts of the process or on-site electricity production can be obtained from the heat exchanger 118. The cooled combustion gases can then be heat exchanged to pre-heat the air or oxygen source passing to the salt heater 112 in the pre-heater 116.

In some embodiments, the molten salt heater 112 can comprise a molten salt vessel, molten salt disposed within the molten salt vessel, and a heat source such as an indirect heat exchanger disposed within the molten salt vessel in contact with the molten salt. When indirect heat exchange is used, the molten salt heater can comprise conduits configured to receive a heat exchange fluid and provide heat to the molten salt. Due to the high temperature in the molten salt heater, the conduits can be formed of materials capable of withstanding the heat while also being structurally stable to the pressures within the salt heater 112. In some embodiments, the conduits can be formed from SiC, a SiC/SiC composite, an alumina forming alloy (e.g., Kanthal® APMT or aluminized Ni superalloy), or a layered metal composite (e.g., Ni-2O1/Haynes 230), or a combination thereof. In general, the conduits can be configured to operate up to at least 1000° C., at least 1100° C., or at least 1200° C. In some embodiments, the indirect heat exchanger comprises an electric heating element immersed in the molten salt. The use of electric heating elements can be in place of a direct or indirect heat exchanger or an addition to another heat exchange system. For example, electric heating elements may be useful during startup, even if not used during the main operation of the system.

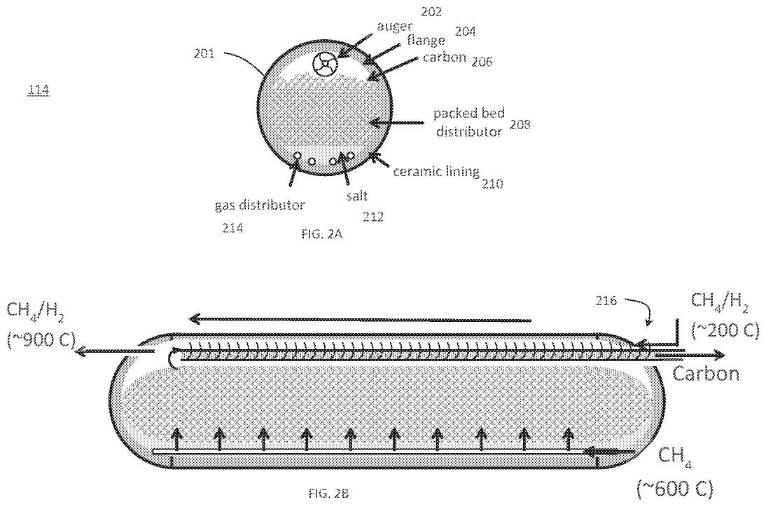

The molten salt from the salt heater 112 can then circulate to the molten salt reactor 114, which is described in more detail with reference to FIG. 2. The gas contacting the molten salt in the molten salt reactor 114 can produce hydrogen and solid carbon. The solid carbon can be removed from the molten salt reactor 114 using a disengagement mechanism 122 such as an auger as described in more detail herein. The carbon can then be transferred to a carbon storage vessel 120. The carbon can be removed from the carbon storage vessel 120 for sale or transport to another process.

In some aspects, the reactor 114 and heater 112 can comprise a molten salt and a metal, for example, a solid metallic component or a molten metal component. Suitable solid components can be used such as solid metals, metal oxides, metal carbides, and in some embodiments, solid carbon, can also be present within the reactor 114 as catalytic components. For example, solid components can be present within the reactor 114 and can include, but are not limited to a solid comprising a metal (e.g. Ni, Fe, Co, Cu, Pt, Ru, etc.), a metal carbide (e.g. MoC, WC, SiC, etc.), a metal oxide (e.g. MgO, CaO, Al₂O₃, CeO₂, etc.), a metal halide (e.g., MgF₂, CaF₂, etc.), solid carbon, and any combination thereof. The solid component can be present as particles present as a slurry or as a fixed component within the reactor. The particles can have a range of sizes, and in some embodiments, the particles can be present as nano and/or micro scale particles. Suitable particles can include elements of magnesium, iron, aluminum, nickel, cobalt, copper, platinum, ruthenium, cerium, combinations thereof, and/or oxides thereof. In some embodiments, the reactor 114 can comprise a liquid comprising a molten metal such as nickel, bismuth, copper, platinum, indium, lead, gallium, iron, palladium, tin, cobalt, tellurium, ruthenium, antimony, gallium, oxides thereof, or any combination thereof. For example, combinations of metals having catalytic activity for hydrocarbon pyrolysis can include, but are not limited to: nickel-bismuth, copper-bismuth, platinum-bismuth, nickel-indium, copper-indium, copper-lead, nickel-gallium, copper-gallium, iron-gallium, palladium-gallium, platinum-tin, cobalt-tin, nickel-tellurium, and/or copper-tellurium. While discussed herein in terms of molten salts, additional materials such as those described herein can also be present in the reactor 114 and/or heater 112.

In some embodiments, the molten salt heater 112 may not be present and rather, the heating elements described with respect to the molten salt heater 112 can be present within the molten salt reactor 114 alone. For example, the indirect heat exchange elements and/or the electric heating elements can be present in the molten salt reactor 114 to heat the molten salt directly within the molten salt reactor 114. When the molten salt heater 112 is present, additional heating elements may also be present within the salt reactor 114 to supplement the heat input into the process and/or be used during startup to melt the salt.

The gasses leaving the molten salt reactor can pass to a vapor condenser 124. The vapor products can comprise vaporized salt due to the high temperatures in the molten salt reactor. These salts need to be removed to prevent loss of the salt as well as preventing fouling from condensing salt in downstream components and corrosion due to the presence of the salts. Any salts condensed in the vapor condenser 124 can be recycled back to the molten salt reactor 114.

In use, the vaporized salts can be condensed by cooling the vapor product from the molten salt reactor 114 in a heat exchanger such as a vapor condenser 124. The vapor product can comprise a vaporized salt. At least a portion of the vaporized salt in the vapor product can be condensed in the heat exchanger 124 as a result of the cooling. The condensed portion of the vaporized salt can then be recycled to the molten salt reactor 114. In general water can be used as the heat exchange fluid, and the water in a water stream can be vaporized in the heat exchanger 124 based on heat exchange with the vapor product. Steam can be produced from the heat exchange in response to vaporizing the water. The steam can then be used in other processes within the system.

The vapor condenser 124 can produce a cooled vapor product, where the cooled vapor product has the portion of the vaporized salt removed. In general, the cooled vapor product can be at a temperature of 800° C. or less to adequately condense the salt in the vapor product. The product gases can then be further cooled in a fuel pre-heater exchanger 126 and/or the feed preheaters 110 and 106 as described above. A portion of the product gases that are cooled can then be recycled to a point upstream of the molten salt reactor 114. For example, the cooled product gases can be recycled to the carbon storage vessel 120, the carbon disengagement mechanism 122, and/or the molten salt reactor 114. The use of the recycle gas can serve to extract heat from the carbon product, reduce the salt vapor pressure in the reactor product gas stream, and/or reduce the temperature of the reactor product gas stream.

The remaining product gas can pas to a heat exchanger 128 where it can be cooled (e.g., using water or another coolant) before passing to a pressure swing absorption (PSA) unit 130. The PSA unit can produce a hydrogen product stream and a recycle stream that can be passed back as a fuel stream for use in the hater 112. The resulting product hydrogen stream can be pure or substantially pure in some embodiments. The exact hydrogen purity may be determined by downstream processing needs.

FIGS. 2A-2B illustrate a reactor configuration that can be used for the molten salt reactor in some embodiments. As shown, the molten salt reactor 114 can comprise a reactor vessel 201, a gas distributor 214 disposed in a lower portion of the reactor vessel 201, an auger 202 disposed in an upper portion of the reactor vessel 201 and an outlet 216 in an upper portion of the reactor vessel 201. The auger 202 can pass through the outlet 216 and is configured to pass carbon out of the upper portion of the reactor vessel 201 through the outlet 216. The reactor vessel 201 can take a variety of shapes including a horizontal cylinder, which can provide pressure handling for high operating pressures. A molten salt 212 can be disposed within the reactor vessel 201, and a headspace can be formed above the molten salt 212 within the reactor vessel 201. The auger 202 can be disposed in the headspace above the molten salt 212, where the carbon 206 can accumulate on top of the molten salt 212 based on density differences. A flange 204 can be disposed within the upper portion of the reactor vessel 201, and the auger 202 can be mounted on the flange 204. Within the reactor vessel 201, the reactive elements can comprise a molten salt 212 alone, or a packed bed distributor 208 can be present with the molten salt disposed therein. The packed bed distributor 208 can comprise a variety of solid components, including any of those described with respect to the solid components disposed within the reactor 114 herein (e.g., a metal, a metal carbide, a metal oxide, a metal halide, solid carbon, and any combination thereof). The reactor vessel 201 can comprise a lining 210 such as a refractory or ceramic lining to help prevent corrosion. Additional flow inlets and outlets for the molten salt can also be present to send and receive molten salt from the molten salt heater. In some embodiments, a recycle line can provide a recycle gas into the reactor vessel 201. The recycle can pass from the recycle line, through the reactor vessel, and through the outlet 216.

In use, the molten salt reactor 114 can operate by contacting a hydrocarbon gas with a molten material such as a molten salt 212 in the reactor vessel 201. The hydrocarbon gas can be introduced into the reactor vessel 201 through the gas distributor 214 to provide increased surface area and contact between the hydrocarbon gas and the molten salt 212. The resulting reaction can produce hydrogen and solid carbon in the reactor vessel 201. The solid carbon can be transported from a top of the molten salt 212 using the auger 202 disposed in an upper portion of the reactor vessel 201 towards the outlet 216 in the reactor vessel 201. The solid carbon can then be removed from the reactor vessel 201 through the outlet 216 in the reactor vessel 201. In some embodiments, a cooled product gas can be introduced into and passed through the reactor vessel 201. The cooled product gas can then help to control a temperature in the reactor vessel 201 using the cooled product gas.

An appendix is included with this description that includes additional information and aspects, the entirely of which is incorporated herein. All of the embodiments disclosed in the Appendix can be operated with the systems and methods described herein as reflected in this description, figures, and claims.

Having described certain aspects of the systems and methods described herein, certain embodiments an include, but are not limited to:

In a first embodiment, a molten salt heater comprises: a molten salt vessel; molten salt disposed within the molten salt vessel; and an indirect heat exchanger disposed within the molten salt vessel in contact with the molten salt.

A second embodiment can include the molten salt heater of the first embodiment, wherein the indirect heat exchanger comprises: conduits configured to receive a heat exchange fluid and provide heat to the molten salt.

A third embodiment can include the molten salt heater of the first or second embodiment, wherein the conduits are formed from SiC, a SiC/SiC composite, an alumina forming alloy (e.g., Kanthal® APMT or aluminized Ni superalloy), or a layered metal composite (e.g., Ni-2O1/Haynes 230), or a combination thereof.

A fourth embodiment can include the molten salt heater of the second or third embodiment, wherein the conduits are configured to operate up to 1000° C.

A fifth embodiment can include the molten salt heater of the first embodiment, wherein the indirect heat exchanger comprises a electric heating element immersed in the molten salt.

In a sixth embodiment, a molten salt reactor comprises: a reactor vessel; a gas distributor disposed in a lower portion of the reactor vessel; an auger disposed in an upper portion of the reactor vessel; and an outlet in an upper portion of the reactor vessel, wherein the auger passes through the outlet and is configured to pass carbon out of the upper portion of the reactor vessel through the outlet.

A seventh embodiment can include the molten salt reactor of the sixth embodiment, wherein the reactor vessel comprises a horizontal cylinder.

An eighth embodiment can include the molten salt reactor of the sixth or seventh embodiment, further comprising: a molten salt disposed within the reactor vessel, wherein a headspace is formed above the molten salt within the reactor vessel.

A ninth embodiment can include the molten salt reactor of the eighth embodiment, wherein the auger is disposed in the headspace above the molten salt.

A tenth embodiment can include the molten salt reactor any one of the sixth to ninth embodiments, further comprising: a recycle gas inlet line; and a recycle gas outlet in the reactor, wherein the recycle gas inlet line is in fluid communication with the outlet and is configured to pass a recycle gas into the reactor vessel through the outlet, and wherein the recycle gas outlet is configured to remove the recycle gas from the reactor vessel.

An eleventh embodiment can include the molten salt reactor any one of the sixth to tenth embodiments, further comprising: a packed bed disposed within the reactor vessel.

A twelfth embodiment can include the molten salt reactor any one of the sixth to eleventh embodiments, wherein the reactor vessel comprises a ceramic lining.

A thirteenth embodiment can include the molten salt reactor any one of the sixth to twelfth embodiments, further comprising: a flange disposed within the upper portion of the reactor vessel, wherein the auger is mounted on the flange.

In a fourteenth embodiment, a method of operating a molten salt reactor comprises: contacting a hydrocarbon gas with a molten salt in a reactor vessel; producing hydrogen and solid carbon in the reactor vessel; transporting the solid carbon from a top of the molten salt using an auger disposed in an upper portion of the reactor vessel towards an outlet in the reactor vessel; and removing the solid carbon from the reactor vessel through the outlet in the reactor vessel.

A fifteenth embodiment can include the method of the fourteenth embodiment, further comprising: introducing the hydrocarbon gas into the reactor vessel through a distributor disposed in a lower portion of the reactor vessel.

A sixteenth embodiment can include the method of the fourteenth or fifteenth embodiment, wherein the reactor vessel comprises a horizontal cylinder.

A seventeenth embodiment can include the method of any one of the fourteenth to sixteenth embodiments, wherein the molten salt is disposed within the reactor vessel, wherein a headspace is formed above the molten salt within the reactor vessel, and wherein the solid carbon floats in the headspace within the reactor vessel.

An eighteenth embodiment can include the method of any one of the fourteenth to seventeenth embodiments, wherein the auger transports the solid carbon from the headspace to the outlet.

A nineteenth embodiment can include the method of any one of the fourteenth to eighteenth embodiments, further comprising: introducing a cooled product gas into the reactor vessel; passing the cooled product gas through the reactor vessel; and controlling a temperature in the reactor vessel using the cooled product gas.

A twentieth embodiment can include the method of any one of the fourteenth to nineteenth embodiments, wherein the reactor vessel comprises a flange disposed within the upper portion of the reactor vessel, wherein the auger is mounted on the flange.

In a twenty first embodiment, a method of preheating a feed to a molten salt reactor comprises: heating a hydrocarbon feed in a first heat exchanger using a cooled product gas to produce a heated hydrocarbon feed stream, wherein the heated hydrocarbon feed stream comprises methane and one or more C₂₊ hydrocarbons; pyrolyzing at least a portion of the C₂₊ hydrocarbons in the heated feed stream in a pyrolysis reactor to produce a pyrolyzed hydrocarbon stream; heating the pyrolyzed hydrocarbon stream in a second heat exchanger using a product gas to produce a pre-heated feed gas.

A twenty second embodiment can include the method of the twenty first embodiment, further comprising: cooling the product gas in the second heat exchanger to produce the cooled product gas.

A twenty third embodiment can include the method of the twenty first or twenty second embodiment, wherein the heated hydrocarbon feed stream has a temperature of between 40-850° C.

A twenty fourth embodiment can include the method of any one of the twenty first to twenty third embodiments, wherein the pre-heated feed gas stream has a temperature of between 700-1100° C.

A twenty fifth embodiment can include the method of any one of the twenty first to twenty fourth embodiments, further comprising: preventing pyrolysis of the heated hydrocarbon feed stream in the second heat exchanger based on pyrolyzing the portion of the C₂₊ hydrocarbons in the heated feed stream.

A twenty sixth embodiment can include the method of any one of the twenty first to twenty fifth embodiments, wherein the pyrolysis reactor comprises a pyrolysis catalyst.

A twenty seventh embodiment can include the method of the twenty sixth embodiment, wherein the pyrolysis catalyst comprises carbon, nickel, or the like.

A twenty eighth embodiment can include the method of any one of the twenty first to twenty seventh embodiments, wherein the second heat exchanger comprises a material in contact with the pyrolyzed hydrocarbon stream that is configured to be non-catalytic to pyrolysis reactions.

A twenty ninth embodiment can include the method of any one of the twenty first to twenty eighth embodiments, wherein the second heat exchanger comprises a material in contact with the pyrolyzed hydrocarbon stream comprising SiC or an alumina forming alloy (e.g., Kanthal® APMT or aluminized Ni superalloy).

In a thirtieth embodiment, a method of condensing vaporized salt comprises: cooling a vapor product from a molten salt reactor in a heat exchanger, wherein the vapor product comprises a vaporized salt; condensing at least a portion of the vaporized salt in the vapor product in the heat exchanger; and recycling the condensed portion of the vaporized salt to the molten salt reactor.

A thirty first embodiment can include the method of the thirtieth embodiment, further comprising: vaporizing water in a water stream in the heat exchanger based on heat exchange with the vapor product; and producing steam from the heat exchange in response to vaporizing the water.

A thirty second embodiment can include the method of the thirtieth or thirty first embodiment, further comprising: producing a cooled vapor product in the heat exchanger, wherein the cooled vapor product has the portion of the vaporized salt removed.

A thirty third embodiment can include the method of the thirty second embodiment, wherein the cooled vapor product has temperature of 700° C. or less.

A thirty fourth embodiment can include the method of the thirty second or thirty third embodiment, further comprising: recycling a portion of the cooled vapor product upstream of the molten salt reactor; and limiting a temperature within the molten salt reactor using the recycled portion of the cooled vapor product.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although claims may be formulated in this application or of any further application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

1. A molten reactor heater comprising:
a molten reactor vessel;
a molten material disposed within the molten reactor vessel; and
an indirect heat exchanger disposed within the molten reactor vessel in contact with the molten material.

2. The molten reactor heater of claim 1, wherein the molten material comprises molten salt.

3. The molten reactor heater of claim 1, wherein the indirect heat exchanger comprises:
conduits configured to receive a heat exchange fluid and provide heat to the molten material.

4. The molten reactor heater of claim 3, wherein the conduits are formed from SiC, a SiC/SiC composite, an alumina forming alloy, or a layered metal composite, or a combination thereof.

5. (canceled)

6. The molten reactor heater of claim 1, wherein the indirect heat exchanger comprises an electric heating element immersed in the molten material.

7. The molten reactor heater of claim 1, further comprising:
an auger disposed in an upper portion of the reactor vessel; and
an outlet in an upper portion of the reactor vessel, wherein the auger passes through the outlet and is configured to pass carbon out of the upper portion of the reactor vessel through the outlet.

8.-10. (canceled)

11. The molten reactor heater of claim 7, further comprising:
a recycle gas inlet line; and
a recycle gas outlet in the reactor, wherein the recycle gas inlet line is in fluid communication with the outlet and is configured to pass a recycle gas into the reactor vessel through the outlet, and wherein the recycle gas outlet is configured to remove the recycle gas from the reactor vessel.

12.-14. (canceled)

15. A method of operating a molten material reactor, the method comprising:
contacting a hydrocarbon gas with a molten material in a reactor vessel;
producing hydrogen and solid carbon in the reactor vessel;
transporting the solid carbon from a top of the molten material using an auger disposed in an upper portion of the reactor vessel towards an outlet in the reactor vessel; and
removing the solid carbon from the reactor vessel through the outlet in the reactor vessel.

16. The method of claim 15, wherein the molten material comprises a molten salt.

17. The method of claim 15, further comprising:
introducing the hydrocarbon gas into the reactor vessel through a distributor disposed in a lower portion of the reactor vessel.

18. The method of claim 15, wherein the reactor vessel comprises a horizontal cylinder.

19. The method of claim 15, wherein the molten salt is disposed within the reactor vessel, wherein a headspace is formed above the molten salt within the reactor vessel, and wherein the solid carbon floats in the headspace within the reactor vessel.

20. The method of claim 15, wherein the auger transports the solid carbon from the headspace to the outlet.

21. The method of claim 15, further comprising:
introducing a cooled product gas into the reactor vessel;
passing the cooled product gas through the reactor vessel; and
controlling a temperature in the reactor vessel using the cooled product gas.

22. The method of claim 15, wherein the reactor vessel comprises a flange disposed within the upper portion of the reactor vessel, wherein the auger is mounted on the flange.

23.-31. (canceled)

32. A method of condensing vaporized material, the method comprising:
cooling a vapor product from a molten salt reactor in a heat exchanger, wherein the vapor product comprises a vaporized salt;
condensing at least a portion of the vaporized salt in the vapor product in the heat exchanger; and
recycling the condensed portion of the vaporized salt to the molten salt reactor.

33. The method of claim 32, further comprising:
vaporizing water in a water stream in the heat exchanger based on heat exchange with the vapor product; and
producing steam from the heat exchange in response to vaporizing the water.

34. The method of claim 32, further comprising:
producing a cooled vapor product in the heat exchanger, wherein the cooled vapor product has the portion of the vaporized salt removed.

35. The method of claim 34, wherein the cooled vapor product has temperature of 700° C. or less.

36. The method of claim 34, further comprising:
recycling a portion of the cooled vapor product upstream of the molten salt reactor; and
limiting a temperature within the molten salt reactor using the recycled portion of the cooled vapor product.
